(19) United States
(12) Patent Application Publication
(10) Pub. No.: US 2008/0152964 A1
(43) Pub. Date: Jun. 26, 2008

(54) Technique and apparatus to regulate a reactant stoichiometric ratio of a fuel cell system

(76) Inventors: Jing Ou, Latham, NY (US); Zhi Zhou, Selkirk, NY (US); Dustan L. Skidmore, Latham, NY (US); John W. Parks, Loudonville, NY (US)

Correspondence Address: TROP PRUNER & HU, PC, 1616 S. VOSS ROAD, SUITE 750, HOUSTON, TX, 77057-2631, US

(21) Appl. No.: 11/645,153

(22) Filed: Dec. 22, 2006

(51) Int. Cl. H01M 8/04

(52) U.S. Cl. 429/13; 429/22

(57) ABSTRACT

A technique that is useable with a fuel cell system includes adjusting operating parameters of a fuel cell system to obtain an optimal reactant stoichiometric ratio and thereby maximize the operating efficiency and/or performance of the system. An initial starting point for the reactant stoichiometric ratio is determined based on the output power provided by a fuel cell stack. Thereafter, the optimal reactant stoichiometric ratio is obtained by adjusting the reactant stoichiometric ratio based upon the observed system operating parameters and their response to the adjustment. In this manner, an optimal reactant stoichiometric ratio is reached and maintained while the fuel cell system is in operation, thus, maximizing the system's efficiency and performance.

### BACKGROUND

The invention generally relates to a technique and apparatus to regulate a reactant stoichiometric ratio of a fuel cell system.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C) to 70° C. temperature range. Another type employs a phosphoric-acid-based polybenziamidazole, PBI, membrane that operates in the 150° C. to 200° C. temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system. For example, the fuel cell system may also include a cooling subsystem to regulate the temperature of the stack, a cell voltage monitoring subsystem, a control subsystem, a power conditioning subsystem to condition the power that is provided by the fuel cell stack for the system load, etc. The particular design of each of these subsystems is a function of the application that the fuel cell system serves.

The fuel cell system also may include a fuel processor that converts a hydrocarbon (natural gas, propane methanol, as examples) into the fuel for the fuel cell stack. To provide output power from the fuel cell stack, the reactant flows (i.e., the fuel and oxidant flows) to the stack must satisfy the appropriate stoichiometric ratios governed by the equations listed above. With respect to the fuel flow provided to the stack, the hydrogen stoichiometric ratio is defined as the ratio between the amount of hydrogen provided to the stack and the amount of hydrogen consumed by the stack. To maximize the efficiency of the stack, the hydrogen stoichiometric ratio should be minimized. Theoretically, the minimum hydrogen stoichiometric ratio is 1.1, which indicates that ten percent of the fuel provided to the stack is not consumed. In practice, however, the minimum achievable hydrogen stoichiometric ratio generally is greater than 1.1 and varies based on the output power provided by the stack to the load. To deal with this variation, a controller of the fuel cell system may monitor the output power of the stack and, based on the monitored output power, estimate the fuel flow to satisfy the hydrogen stoichiometric ratio. The controller regulates the fuel processor to produce this flow, and, in response to the controller detecting a change in the output power, the controller estimates a new rate of fuel flow and controls the fuel processor accordingly.

Due to non-ideal characteristics of the stack, it may be difficult to precisely predict the rate of fuel flow needed for a given output power. Moreover, as the fuel cell system ages, the fuel flow needed for a given output power may change. To take into account these uncertainties, the controller may build in a sufficient margin of error by causing the fuel processor to provide more fuel than is necessary to ensure that the cells of the stack receive enough fuel and, thus, are not starved. However, such a control technique may be quite inefficient, as the fuel cell stack typically does not consume all of the incoming fuel, leaving unconsumed fuel that may be burned off by an oxidizer of the fuel cell system. As the fuel cell system ages, this control technique may become even more inefficient as it does not take into account the degradation of the fuel cell system.

Thus, there is a continuing need for an arrangement and/or technique to address one or more of the problems discussed above.

### SUMMARY

In an embodiment of the invention, a technique useable with a fuel cell system that provides power to a load includes providing a reactant flow to a fuel cell stack, monitoring a plurality of operating parameters that are indicative of a reactant stoichiometric ratio, and determining a target range for at least one of the operating parameters based on an output power level provided by the fuel cell stack. The technique further includes determining a step size for adjusting the reactant stoichiometric ratio based on a difference between at least one of the monitored parameters and its target range. The technique also includes adjusting the reactant stoichiometric ratio in increments in accordance with the step size until a desired performance level of the system is reached. The desired performance level may be indicated when at least one of the operating parameters is approximately within its target range.

In another embodiment of the invention, a fuel cell system includes a fuel cell stack to provide power to a load, a fuel processor to provide a fuel flow to the fuel cell stack, and a circuit. The circuit is configured to monitor a plurality of operating parameters of the fuel cell system that are indicative of a hydrogen stoichiometric ratio, determine a target range for at least one of the operating parameters based on the output power level provided by a fuel cell stack, and determine a step size for adjusting the hydrogen stoichiometric ratio based on a difference between at least one of the monitored parameters and its target range. The circuit is further configured to adjust the hydrogen stoichiometric ratio in increments in accordance with the step size until at one of the monitored operating parameters is approximately within its target range.

In yet another embodiment of the invention, an article comprising a computer readable storage medium that is accessible by a processor-based system stores instructions. When executed by the processor-based system, the stored instructions cause the processor-based system to monitor a plurality of operating parameters of a fuel cell system that are indicative of a reactant stoichiometric ratio, determine a target range for at least one of the operating parameters based on an output power level provided by a fuel cell stack, and determine a step size for adjusting the reactant stoichiometric ratio based on a difference between at least one of the monitored operating parameters and its target range. The instructions further cause the processor-based system to adjust the reactant stoichiometric ratio in increments in accordance with the step size until at least one of the operating parameters is approximately within its target range.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to adjust the reactant stoichiometric ratio of the fuel cell system of FIG. 1 according to an embodiment of the invention.

FIG. 3 is a flow diagram depicting a further technique to adjust the hydrogen stoichiometric ratio of the fuel cell system of FIG. 1 according to an embodiment of the invention.

FIG. 4 is a flow diagram depicting yet a further technique to adjust the hydrogen stoichiometric ratio of the fuel cell system of FIG. 1 according to an embodiment of the invention.

### DETAILED DESCRIPTION

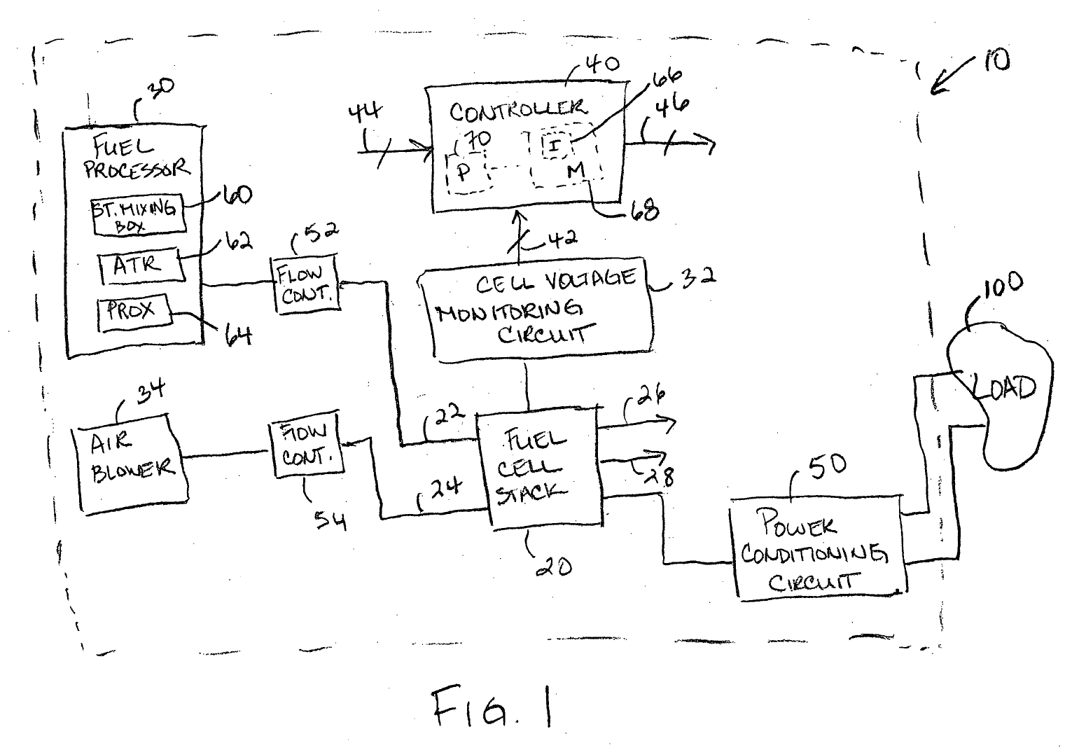

Referring to FIG. 1, in accordance with an embodiment of the invention, a fuel cell system 10 includes a fuel cell stack 20 (a PEM fuel cell stack, for example) that, in response to fuel and oxidant flows produces power for an electrical load 100. Powering conditioning circuitry 50 of the fuel cell stack converts a DC stack voltage of the fuel cell stack 20 into the appropriate voltage (DC or AC, depending on the type of load) for the load 100. For example, the load 100 may be a residential load and, may receive an AC voltage from the fuel cell system 10. However, in other embodiments of the invention, the fuel cell system 10 may provide a DC output voltage for the case where the load 100 is a DC load. Other variations are possible and are within the scope of the appended claims.

In accordance with embodiments of the invention, a fuel processor 30 (a reformer, for example) of the fuel cell system 10 receives a hydrocarbon and produces a corresponding fuel flow (called “reformate”) to the fuel cell stack 20. The fuel flow from the fuel processor 30 may pass, for example, through a flow control 52 (one or more valves and/or a pressure regulator, as examples) to anode inlet 22 of the fuel cell stack 20. An air blower 34 may produce an air flow (i.e., the oxidant flow) that passes through the oxidant flow control 54 to a cathode inlet 24 of the fuel cell stack 20. The incoming oxidant flow to the fuel stack 20 passes through the oxidant flow channels of the fuel cell stack 20 to appear as cathode exhaust at a cathode outlet 28 of the stack 20, and the incoming fuel flow to the stack 20 passes through fuel flow channels of the fuel cell stack 20 to appear as anode exhaust at an anode outlet 26 of the stack 20.

In the embodiment illustrated in FIG. 1, fuel cell system 10 further includes a controller 40 that is generally configured to control the power produced by fuel stack 20 by controlling the fuel and oxidant flows provided by fuel processor 30 and air blower 34, respectively. Controller 40 bases its regulation of the fuel and oxidant flows on various measured operating parameters of the fuel cell system 10. The monitored operating parameters are indicators of various different operating conditions of the fuel cell system 10 and, thus, generally also may be indicators of how efficiently the fuel cell system 10 is operating. These operating parameters include, for instance, cell voltages detected by a cell voltage monitoring circuit 32 that monitors the cell voltages of each of the fuel cells in fuel cell stack 20, temperatures of various subsystems associated with the fuel processor 30, etc.

In one embodiment, controller 40 may obtain indications representative of the various system operating parameters via, for example, communication bus 42 and communication bus 44. Controller 40 may provide control signals to various subsystems of system 10 in response to the indications of the monitored operating parameters via, for example, communication bus 46. For instance, the control signals may be provided to adjust the hydrogen stoichiometric ratio (referred to as the “H₂ Stoic”), regulate the efficiency of system 10, recover from undesirable operating conditions, etc.

The H₂ Stoic is the ratio between the amount of fuel provided to the stack 20 and the amount of fuel consumed by the stack 20 and, thus, also is an indicator of the operating efficiency of system 10. An optimal H₂ Stoic is reached when substantially all of the fuel provided to the stack 20 is consumed by the stack 20. Theoretically, the optimal H₂ Stoic is approximately 1.1, which indicates that ten percent of the fuel provided to the stack is not consumed. In practice, the optimal H₂ Stoic is greater than 1.1 and varies based on the amount of power being provided to load 100. Typically, the optimal H₂ Stoic at a high power output level is smaller than at a low power output level. In addition to varying with power output level, the optimal H₂ Stoic also tends to increase as the fuel cell system 10 degrades. Accordingly, to achieve an optimal H₂ Stoic for all operating conditions and as system 10 ages, the H₂ Stoic may be adjusted while the system 10 is in operation based on indications of various system operating parameters.

In one embodiment, system operating parameters that may be used to guide the adjustment of the H₂ Stoic are parameters that are indicative of the performance of stack 20 and the performance of fuel processor 30. Once an adjustment is made to the H₂ Stoic, further adjustments may be implemented by observing the responses of various operating parameters to the initial adjustment. Operating parameters associated with the performance of stack 20 typically are indicated by the cell voltages measured by cell voltage monitoring system 32. For instance, various pieces of information derived from the cell voltages may indicate whether the stack 20 is starved of fuel, which indicates that the H₂ Stoic is not at an optimal level.

With respect to parameters associated with the fuel processor 30, the fuel processor includes various subcomponents having operating parameters that are indicative of the H₂ Stoic. As an example, the fuel processor 30 may include a steam mixing box 60 to mix the incoming fuel, air and steam streams before the mixture is heated and reacted in an autothermal reformer 62 of the fuel processor 30. In addition to the steam mixing box 60 and the autothermal reformer 62, the fuel processor 30 may include, for instance, a preferential oxidation reactor (PrOx) 64. If the temperature of any of the steam mixing box 60, the autothermal reformer 62, or the PrOx 64 is too low, this may be an indication that the fuel processor 30 may not be able to produce enough hydrogen to attain an optimal H₂ Stoic or that high levels of carbon monoxide (i.e., carbon monoxide poisoning) may result in the stack 20. Thus, upon receipt of indications of parameters indicative of stack 20 performance or reformer 30 performance, controller 40 may implement a routine 200 to adjust certain system parameters and thereby adjust the H₂ Stoic and/or the O₂ Stoic to an optimal level that maximizes the efficiency and/or optimizes the performance of the fuel cell system 10.

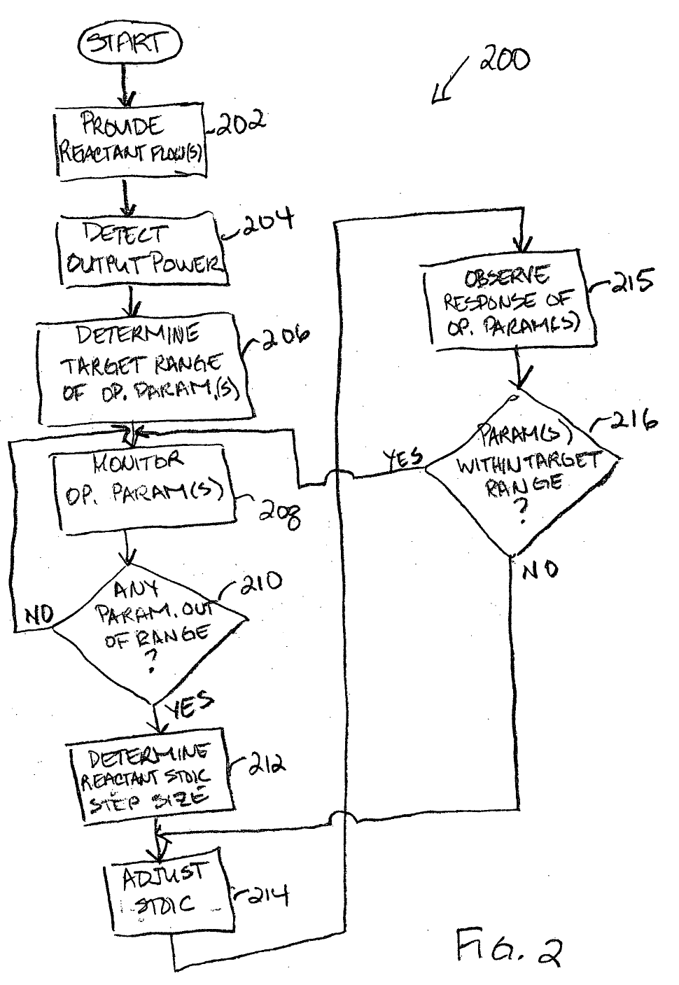

Such a routine 200 is illustrated in the flow diagram of FIG. 2. The routine 200 may be embodied in program instructions 66 stored in a memory 68 in controller 40. When the program instructions 66 are executed by a processor 30, the controller 40 operates as described herein to obtain indications of fuel cell system operating parameters and to adjust the operation of system 10 based on those parameters to attain an optimal reactant stoichiometric ratio, which corresponds to the system 10 operating at a performance level that best utilizes the reactant flows while also not resulting in damage to the stack 20. For instance, this performance level may be deemed reached when the stack 20 consumes substantially all of the reactant provided to the stack while at the same time is not starved (i.e., not enough fuel is provided to the stack).

The routine 200 illustrated in FIG. 2 assumes that the system 10 is started up from a powered down state. In accordance with routine 200, controller 40 provides a predetermined reactant flow to stack 20, such as a predetermined fuel flow and/or a predetermined oxidant flow. Typically, the predetermined reactant flow is a conservative estimation of the required reactant flow for an assumed level of output power provided by the stack 20. Generally, this initial level of reactant flow results in the provision of more reactant to the stack 20 than needed. Once the system 10 is powered up by providing a reactant flow to stack 20, the amount of output power provided by the fuel cell stack 20 is detected (block 204). The output power may be detected, for instance, by detecting the amount of current drawn from the stack 20 and providing indications of the detected current to the controller 40. Based on the detected output power, controller 40 determines a target range for one or more system operating parameters that have been selected for aiding in the adjustment of the reactant stoichiometric ratio (block 206).

Having determined the target range for the operating parameters, those parameters are observed (block 208). If any one or more of the operating parameters are outside of the target range (diamond 210) (e.g. above or below the target range), then controller 40 determines an appropriate step size for adjusting the reactant stoichiometric ratio to thereby bring the operating parameters within the target range (block 212). In one possible embodiment, the step size may be a fixed step size that has been predetermined. In other embodiments, an adaptive or variable step size may be used which may result in better overall system efficiency. For instance, the larger the difference is between the monitored operating parameters and the target range, the larger the step size of the adjustment can be. By adapting the step size based on a comparison between the target range and the monitored value, the reactant stoichiometric ratio may be more quickly brought to its optimal value, thus maximizing the efficiency of the operation of fuel cell system 10.

Once the step size of the reactant stoichiometric ratio adjustment has been determined, controller 40 then provides the appropriate control signals to adjust the reactant stoichiometric ratio. For instance, if the monitored operating parameters indicate that a non-optimal amount (either too much or too little) of fuel is being provided to stack 20, then controller 40 may provide a control signal to fuel processor 30 or flow control 52 to increase or decrease the fuel flow as needed. Alternatively, if the monitored operational parameters indicate that a temperature of a subsystem of the fuel processor 30 is out of range, such that either fuel starvation or carbon monoxide poisoning may result, controller 40 may provide an appropriate control signal to fuel processor 30 to increase or decrease the temperatures of the subsystems and/or to increase or decrease the flow of fuel provided to stack 20 as needed. Yet further, if the monitored operating parameters indicate that a non-optimal amount (either too much or too little) of oxidant is being provided to stack 20, then controller 40 may provide a control signal to air blower 34 or flow control 54 to increase or decrease the oxidant flow as needed.

After making the adjustment, the controller 40 observes a response of the system to the adjustment (block 215) and determines whether the monitored operating parameters have been brought within their target range (thus indicating that the desired performance level of system 10 has been achieved) (diamond 216). If not, then controller 40 continues to increment the adjustment until the target range is reached. Once the operating parameters are within the target range, controller 40 continues to monitor the operating parameters to determine whether further adjustments are needed while the system 10 is operating.

In some embodiments of the invention, circuitry other than the controller 40 may be used to perform one or more parts of the routine 200. For instance, in some embodiments, the cell voltage monitoring circuit 32 may determine whether a parameter is out of range and indicate to the controller 40 whether to increase or decrease the reactant stoichiometric ratio based on this determination. In other embodiments, the fuel processor 30 may determine whether an operating parameter is out of range and indicate to the controller 40 whether to increase or decrease the reactant stoichiometric ratio based on this determination. For purposes of simplifying the description below, it is assumed that the controller 40 determines whether the reactant stoichiometric ratio can be improved, although other variations are possible.

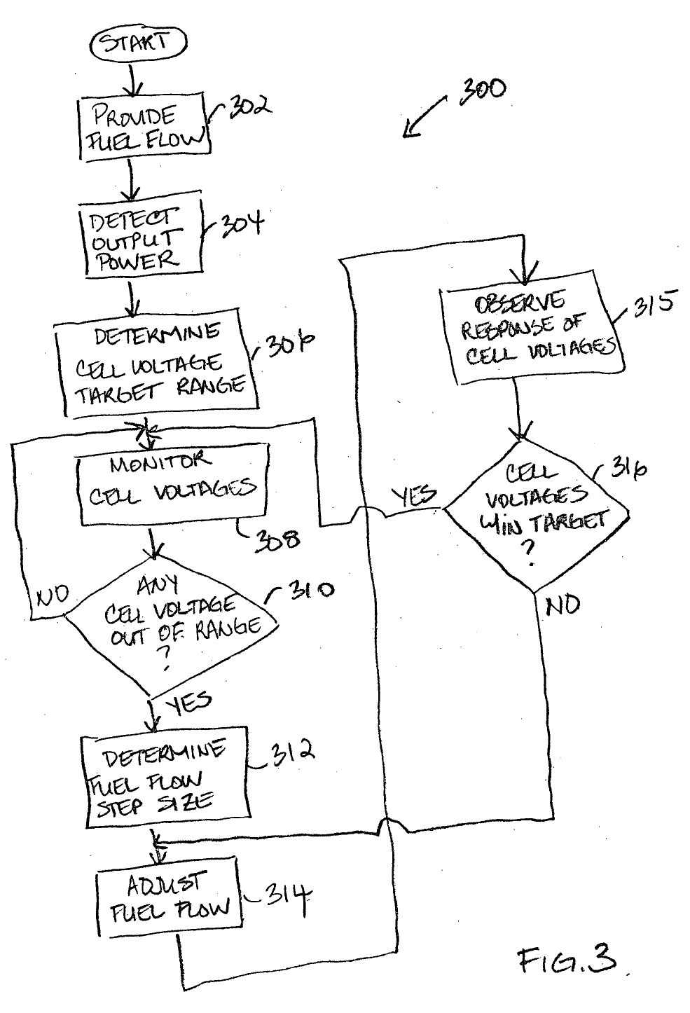

As mentioned above, there are numerous ways for the controller 40 to determine whether the reactant stoichiometric ratio is at an optimal level. For example, FIG. 3 illustrates a routine 300 that the controller 40 may perform to make decision about the H₂ Stoic based on the performance of the stack 20. In accordance with routine 300, the fuel cell system is powered up by providing a fuel flow to stack 20 (block 302). The output power level provided to load 100 is then detected (block 304). A target range for the cell voltages of stack 20 is then determined based on the detected power level (block 306). Controller 40 obtains indications of the cell voltages of stack 20 from, for instance, cell voltage monitoring circuit 32 to determine whether any of these cells are being deprived of sufficient fuel (i.e., an indication that the H₂ Stoic is too low) (block 308). For example, if the controller 40 determines that one or more cell voltages are below the minimum threshold of the range (less than 0.2 volt, for example) such that damage to the membranes of those cells may result (diamond 310), then the controller 40 determines the appropriate step size for adjusting the fuel flow provided to stack 20 (block 312). As mentioned previously, the size of the step may either be fixed at a predetermined size or may be a variable step, the size of which is determined based on the amount of difference between the measured cell voltage and the target range. If, however, at diamond 310, the controller 40 determines that none of the cell voltages are outside of the target range, then controller 40 returns to block 308 to continue to receive indications of the cell voltages.

After determining the step size, controller 40 provides control signals to adjust the fuel provided to stack 20 in accordance with the determined step size (block 314). Controller 40 then observes the response of the cell voltages to the adjusted fuel flow (block 315) and continues to adjust the fuel flow until the cell voltages are within the target range (diamond 316 and block 314). Once the cell voltages are within the target range, controller 40 returns to monitoring the cell voltages at block 308.

In addition to or as an alternative to observing the cell voltages, controller 40 may look at a cell ratio, which is derived from the measured cell voltages, to determine whether the H₂ Stoic is at an optimal level. The cell ratio is the ratio between the lowest cell voltage in the stack 20 and the average of all the cell voltages. As with a cell voltage being outside of a target range, the cell ratio may be indicative of a non-optimal fuel flow provided to the stack 20 and, thus, a non-optimal H₂ Stoic. A standard deviation of the cell voltages also may be examined to determine whether the H₂ Stoic should be adjusted. Generally, the standard deviation may be used as an indicator of carbon monoxide poisoning, which would affect the manner in which the H₂ Stoic may be adjusted.

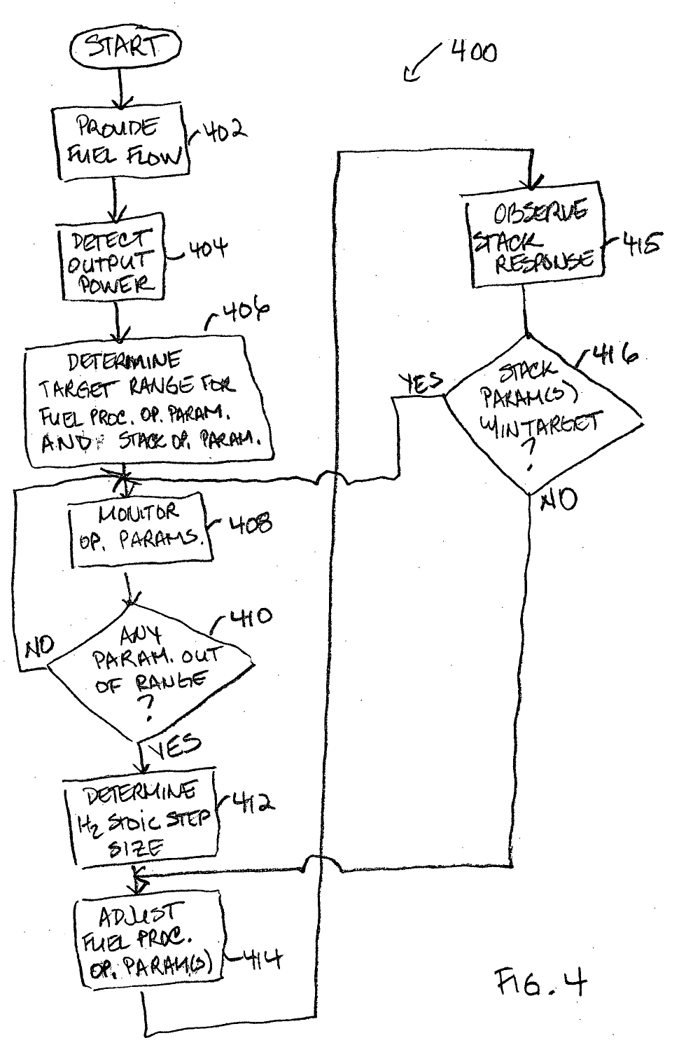

FIG. 4 depicts an alternative routine 400 that the controller 40 may use to determine if the H₂ Stoic may be improved. In the routine 400, a fuel flow is provided to the stack 20 (block 402), an output power is detected (block 404), and a target range for one or more operating parameters associated with the fuel processor 30 and the stack 20 are determined based on the output power (block 406). The controller 40 then monitors one or more operating parameters of the fuel processor 30, such as the steam mixing box 60 temperature, the autothermal reformer 62 temperature, and/or the PrOx 64 temperature, and one or more stack operating parameters, such as the cell voltages (block 408). If any of these parameters are outside of their target range (e.g., a range of 600 to 700° C. for the autothermal reformer 62), this may be an indication that the stack 20 is not at its optimal operating condition. If any parameter is outside of a determined target range, the controller 40 then determines an appropriate step size for adjusting the H₂ Stoic (diamond 410 and block 412). For instance, the further the temperature is from the target range, the larger the step size may be. Alternatively, the step size may be a fixed step size. The controller 40 provides a control signal to the fuel processor 30 to adjust the temperature and/or fuel flow based on the determined step size (block 414) and then observes a response of the stack 20 to the adjusted parameter (block 415), such as the response of one or more cell voltages as indicated by cell voltage monitoring circuit 32. The controller 40 may continue to adjust the temperature of and/or the fuel flow provided by the fuel processor 30 until all of the cell voltages are within the target range (diamond 416). At that point, the controller 40 may return to monitoring one or more operating parameters (block 408) and then continue to adjust the H₂ Stoic based on observed changes in those parameters.

It should be understood that routines 300 and 400 may be implemented separately or in conjunction with each other, various of the steps may be performed in different orders, and fewer or additional steps than those shown in the figures may be performed. In addition, other control loops may be used in combination with either of routine 300 or 400. For example, the controller 40 may adjust the fuel flow in response to a monitored output power of the fuel cell stack 20. However, the controller 60 continues to implement the control provided by the general routine 200 to obtain an optimal reactant stoichiometric ratio and thus maximize the efficiency and/or performance of the fuel cell system 10.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method useable with a fuel cell system, comprising:
providing a reactant flow to a fuel cell stack;
monitoring a plurality of operating parameters of the fuel cell system, the operating parameters being indicative of a reactant stoichiometric ratio;
determining a target range for at least one of the operating parameters based on an output power level provided by the fuel cell stack;
determining a step size for adjusting the reactant stoichiometric ratio based on a difference between at least one of the monitored operating parameters and its target range; and
adjusting the reactant stoichiometric ratio in increments in accordance with the step size until the fuel cell system is operating at a desired performance level.

2. The method of claim 1, wherein adjusting the reactant stoichiometric ratio comprises:
observing a response of at least one of the operating parameters to the adjusted reactant stoichiometric ratio; and
further adjusting the reactant stoichiometric ratio in increments based on the observation until the fuel cell system is operating at the desired performance level.

3. The method of claim 1, wherein the step size of each of the increments is variable.

4. The method of claim 1, wherein the operating parameter is a fuel cell stack operating parameter.

5. The method of claim 1, wherein the operating parameter is a fuel processor operating parameter.

6. The method of claim 1 wherein adjusting the reactant stoichiometric ratio comprises adjusting the fuel flow provided to the fuel cell stack.

7. The method of claim 1, wherein the monitored operating parameters include a fuel processor operating parameter and a fuel cell stack operating parameter, and wherein adjusting the reactant stoichiometric ratio comprises adjusting the fuel processor operating parameter until the fuel cell stack operating parameter is approximately within the target range.

8. The method of claim 1, wherein the fuel cell system is operating at the desired performance level when at least one of the operating parameters is approximately within its target range.

9. A fuel cell system comprising:
a fuel cell stack to provide power to a load;
a fuel processor to provide a fuel flow to the fuel cell stack; and
a circuit configured to:
monitor a plurality of operating parameters of the fuel cell system, the operating parameters being indicative of a hydrogen stoichiometric ratio;
determine a target range for at least one of the operating parameters based on an power level provided by a fuel cell stack;
determine a step size for adjusting the hydrogen stoichiometric ratio based on a difference between at least one of the monitored operating parameters and its target range; and
adjust the hydrogen stoichiometric ratio in increments in accordance with the step size until at least one of the monitored operating parameters is approximately within its target range.

10. The fuel cell system as recited in claim 9, wherein the circuit comprises:
a cell voltage monitoring circuit to monitor cell voltages of the fuel cell stack; and
a controller to receive an indication of the cell voltages from the cell voltage monitoring circuit, determine the target range, determine the step size, and adjust the hydrogen stoichiometric ratio.

11. The fuel cell system as recited in claim 9, wherein the step size is variable.

12. The fuel cell system as recited in claim 9, wherein the controller adjusts the hydrogen stoichiometric ratio by adjusting a fuel processor operating parameter.

13. The fuel cell system as recited in claim 12, wherein the fuel processor operating parameter is a fuel flow provided to the stack.

14. The fuel cell system as recited in claim 12, wherein the fuel processor operating parameter is a temperature.

15. The fuel cell system of claim 9, wherein the circuit is configured to observe a response of at least one of the operating parameters to the adjustment to the hydrogen stoichiometric ratio and to further adjust the hydrogen stoichiometric ratio based on the response.

16. An article comprising a computer readable storage medium accessible by a processor-based system to store instructions that when executed by the processor-based system cause the processor-based system to:
monitor a plurality of operating parameters of a fuel cell system, the operating parameters being indicative of a reactant stoichiometric ratio;
determine a target range for at least one of the operating parameters based on an output power level provided by a fuel cell stack;
determine a step size for adjusting the reactant stoichiometric ratio based on a difference between at least one of the monitored operating parameters and its target range; and
adjust the reactant stoichiometric ratio in increments in accordance with the step size until at least one of the operating parameters is approximately within its target range.

17. The article as recited in claim 16, the storage medium storing instructions that when executed cause the processor-based system to:
observe a response of at least one of the operating parameters to the adjusted reactant stoichiometric ratio; and
further adjust the reactant stoichiometric ratio based on the observation.

18. The article as recited in claim 16, the storage medium storing instructions that when executed cause the processor-based system to adjust the reactant stoichiometric ratio by adjusting a reactant flow provided to the fuel cell stack.

19. The article as recited in claim 16, the storage medium storing instructions that when executed cause the processor-based system to adjust the reactant stoichiometric ratio by adjusting a temperature of a fuel processor that provides a fuel flow to the fuel cell stack.

20. The article as recited in claim 16, wherein at least one of the monitored operating parameters is a cell voltage of the fuel cell stack.
